(19) United States
(12) Patent Application Publication
(10) Pub. No.: US 2025/0088608 A1
(43) Pub. Date: Mar. 13, 2025

(54) LOCATION SWITCHER FOR A CALL CONDUCTED DURING A VIRTUAL EXPERIENCE

(71) Applicant: Roblox Corporation, San Mateo, CA (US)

(72) Inventors: Joshua LI, San Mateo, CA (US); Hendri TAN, San Mateo, CA (US); Charlie LIU, San Mateo, CA (US)

(73) Assignee: Roblox Corporation, San Mateo, CA (US)

(21) Appl. No.: 18/827,219

(22) Filed: Sep. 6, 2024

Related U.S. Application Data
(60) Provisional application No. 63/537,044, filed on Sep. 7, 2023.
(60) Provisional application No. 63/537,050, filed on Sep. 7, 2023.
(60) Provisional application No. 63/548,356, filed on Nov. 13, 2023.

(51) Int. Cl. H04N 7/15

(52) U.S. Cl. CPC H04N 7/157

(57) ABSTRACT

An online virtual experiences server generates a first instance of a virtual experience that is associated with a first client device. The server receives a request from the first client device to initiate a video call with a second client device. The video call is displayed as a user interface that includes a first avatar associated with the first client device and a second avatar associated with the second client device. Responsive to the second client device joining the video call, the server generates a second instance of the virtual experience. The first client device and the second client device teleport to the second instance of the virtual experience. The server receives a confirmation from the first client device and the second client device that the video call is hosted by the second instance of the virtual experience. The confirmation includes an identification of eligible participants for the video call.

### CROSS-REFERENCE TO RELATED APPLICATIONS

This application is a non-provisional application that claims priority under 35 U.S.C. § 119(e) to U.S. Provisional Patent Application No. 63/537,044, filed on Sep. 7, 2023; U.S. Provisional Patent Application No. 63/537,050, filed on Sep. 7, 2023; and U.S. Provisional Patent Application No. 63/548,356, filed on Nov. 13, 2023, the contents of each of which are hereby incorporated by reference herein in its entirety.

### TECHNICAL FIELD

Embodiments relate generally to communications and computer graphics, and more particularly but not exclusively, relates to methods, systems, and computer readable media to teleport avatars in a virtual experience between virtual locations.

### BACKGROUND

A virtual experience is a simulated three-dimensional environment generated from graphical data. Users may be represented within the virtual experience in graphical form by an avatar. The avatar may interact with other users through corresponding avatars, move around in the virtual experience, or engage in other activities or perform other actions within the virtual experience.

A user may interact with the virtual experience through their mobile device. For example, a metaverse application may receive image frames that include the user and generate a corresponding avatar and background.

The user may want to participate in a virtual experience with another user and engage in text, audio, and/or video chat, or other interaction. However, transferring the user to a different virtual location in the virtual experience requires changing between servers, which exposes a client device associated with the user to security risks.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method performed on one or more servers includes generating a first instance of a virtual experience that is associated with a first client device. The method further includes receiving a request from the first client device to initiate a video call with a second client device, wherein the video call is displayed as a user interface that includes a first avatar associated with the first client device and a second avatar associated with the second client device. The method further includes responsive to the second client device joining the video call, generating a second instance of the virtual experience, where the first client device and the second client device teleport to the second instance of the virtual experience and where the first avatar and the second avatar are displayed as being part of the second instance of the virtual experience. The method further includes receiving a confirmation from the first client device and the second client device that the video call is hosted by the second instance of the virtual experience, wherein the confirmation includes an identification of eligible participants for the video call.

In some embodiments, the method further includes receiving a request from the first client device to teleport the first client device to a third instance of the virtual experience, wherein the third instance is displayed with different background characteristics than the second instance; receiving a request from the second client device to teleport the second client device to the third instance of the virtual experience; and responsive to receiving requests from the first client device and the second client device to associate the third instance with the video call, associating the third instance with the video call. In some embodiments, the first instance and the second instance are associated with a first virtual location; the third instance is associated with a second virtual location; and the request to transfer the video call includes a selection of the second virtual location from a set of virtual locations.

In some embodiments, the method further includes prior to the second client device joining the video call, transmitting a request to a call service to trigger a push notification to the second client device to accept the video call and join the second instance of the virtual experience. In some embodiments, the method further includes generating, based on the confirmation, a participant list for the video call that includes a first identifier associated with the first client device and a second identifier associated with the second client device; receiving a request from a third client device to join the video call; and responsive to determining that the third client device is not on the participant list, rejecting the request from the third client device.

In some embodiments, the method further includes receiving a notification that a third client device is associated with the second instance of the virtual experience; determining that the third client device is not associated with the video call; and responsive to determining that the third client device is not associated with the video call, removing the first client device, the second client device, and the third client device from the second instance of the virtual experience.

In some embodiments, the method further includes determining that the first client device left the video call; and responsive to determining that the first client device is absent more than a predetermined amount of time, ending the video call.

A system comprises: one or more processors; and a memory coupled to the one or more processors, with instructions stored thereon that, when executed by the processor, cause the processor to perform operations. The operations include: generating a first instance of a virtual experience that is associated with a first client device; receiving a request from the first client device to initiate a video call with a second client device, wherein the video call is displayed as a user interface that includes a first avatar associated with the first client device and a second avatar associated with the second client device; responsive to the second client device joining the video call, generating a second instance of the virtual experience, where the first client device and the second client device teleport to the second instance of the virtual experience and where the first avatar and the second avatar are displayed as being part of the second instance of the virtual experience; and receiving a confirmation from the first client device and the second client device that the video call is hosted by the second instance of the virtual experience, wherein the confirmation includes an identification of eligible participants for the video call.

In some embodiments, the operations further include receiving a request from the first client device to teleport the first client device to a third instance of the virtual experience, wherein the third instance is displayed with different background characteristics than the second instance; receiving a request from the second client device to teleport the second client device to the third instance of the virtual experience; and responsive to receiving requests from the first client device and the second client device to associate the third instance with the video call, associating the third instance with the video call. In some embodiments, the first instance and the second instance are associated with a first virtual location; the third instance is associated with a second virtual location; and the request to transfer the video call includes a selection of the second virtual location from a set of virtual locations.

In some embodiments, the operations further include prior to the second client device joining the video call, transmitting a request to a call service to trigger a push notification to the second client device to accept the video call and join the second instance of the virtual experience. In some embodiments, the operations further include generating, based on the confirmation, a participant list for the video call that includes a first identifier associated with the first client device and a second identifier associated with the second client device; receiving a request from a third client device to join the video call; and responsive to determining that the third client device is not on the participant list, rejecting the request from the third client device. In some embodiments, the operations further include receiving a notification that a third client device is associated with the second instance of the virtual experience; determining that the third client device is not associated with the video call; and responsive to determining that the third client device is not associated with the video call, removing the first client device, the second client device, and the third client device from the second instance of the virtual experience. In some embodiments, the operations further include determining that the first client device left the video call; and responsive to determining that the first client device is absent more than a predetermined amount of time, ending the video call.

A non-transitory computer-readable medium with instructions stored thereon that, when executed by one or more computers, cause the one or more computers to perform operations. The operations include: generating a first instance of a virtual experience that is associated with a first client device; receiving a request from the first client device to initiate a video call with a second client device, wherein the video call is displayed as a user interface that includes a first avatar associated with the first client device and a second avatar associated with the second client device; responsive to the second client device joining the video call, generating a second instance of the virtual experience, where the first client device and the second client device teleport to the second instance of the virtual experience and where the first avatar and the second avatar are displayed as being part of the second instance of the virtual experience; and receiving a confirmation from the first client device and the second client device that the video call is hosted by the second instance of the virtual experience, wherein the confirmation includes an identification of eligible participants for the video call.

In some embodiments, the operations further include prior to the second client device joining the video call, transmitting a request to a call service to trigger a push notification to the second client device to accept the video call and join the second instance of the virtual experience. In some embodiments, the operations further include generating, based on the confirmation, a participant list for the video call that includes a first identifier associated with the first client device and a second identifier associated with the second client device; receiving a request from a third client device to join the video call; and responsive to determining that the third client device is not on the participant list, rejecting the request from the third client device. In some embodiments, the operations further include receiving a notification that a third client device is associated with the second instance of the virtual experience; determining that the third client device is not associated with the video call; and responsive to determining that the third client device is not associated with the video call, removing the first client device, the second client device, and the third client device from the second instance of the virtual experience.

### BRIEF DESCRIPTION OF THE DRAWINGS

FIGS. 1A-1B illustrate example user interfaces that are used by a first player to request teleportation of the first player and a second player to a same location, according to some embodiments described herein.

FIG. 2 is a block diagram of an example network environment, according to some embodiments described herein.

FIG. 3 is an example block diagram of call invite process, according to some embodiments described herein.

FIG. 4 is an example block diagram of an automatic detection of a call transfer, according to some embodiments described herein.

FIG. 5 is an example block diagram that illustrates how call privacy is enforced, according to some embodiments described herein.

FIG. 6 is an example block diagram that illustrates detection of a client crash, according to some embodiments described herein.

FIG. 7 includes example user interfaces that illustrate how to place a video call and teleport, according to some embodiments described herein.

FIG. 8 includes example user interfaces that illustrate a suggestion to transfer a call that is declined, according to some embodiments described herein.

FIG. 9 is a flow diagram of an example method to enable a video call, according to some embodiments described herein.

FIG. 10 is a block diagram of an example computing device, according to some embodiments described herein.

### DETAILED DESCRIPTION

### Overview

Virtual experiences enable a plurality of players, each with an associated avatar, to participate in activities such as collaborative gameplay (playing as a team), competitive gameplay (one or more users playing against other users, or teams of users competing), virtual meetups (e.g., interactive calling within a virtual experience, birthday parties, meetings within a virtual experience setting, concerts, or other kinds of events where two or more avatars are together at a same location within a virtual experience), etc. When participating together in a virtual experience, players are provided with views of the setting within the virtual experience, e.g., a campfire, a meeting room, etc. Players can view their own avatar and/or the avatars belonging to other players within the virtual experience, each avatar being at a respective position within the virtual experience.

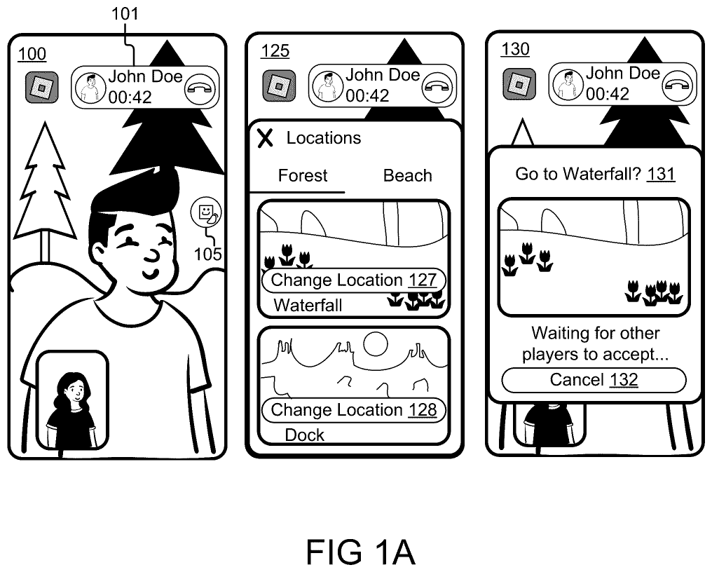

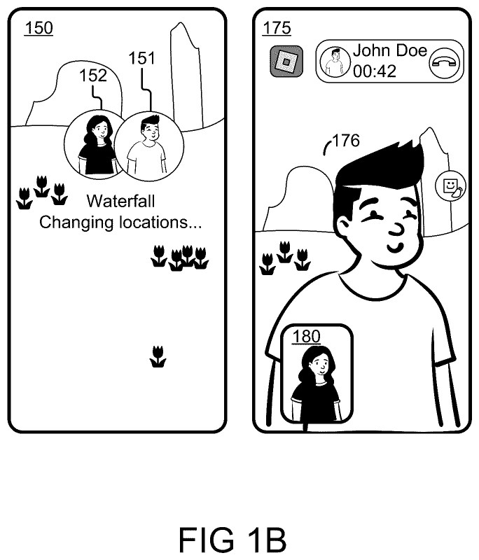

FIGS. 1A-1B illustrate example user interfaces that are used by a first player to request teleportation of the first player and a second player to a same location in a virtual experience, according to some embodiments described herein. In the first user interface 100, a first player has called a second player within the virtual experience and the call has been active for 42 seconds as indicated by the calling time field 101. The avatar of the first player is in a camping area within the virtual experience.

The first player may suggest that the first player and a second player switch locations within the virtual experience. For example, the first player may want to change from a camping location to a waterfall location. The first user selects a teleport button 105 that requests a calling engine to initiate a transfer process.

The second user interface 125 is displayed responsive to the user selecting the teleport button 105 in the first user interface 100. The second user interface 125 includes a variety of options for the first player to select. In this example, the first player selects the change location button 127 that corresponds to a waterfall location. Alternatively, the first player could have selected the change location button 128 to change to a dock location.

In some embodiments, the location change does not occur until both players provide permission to change the location. The third user interface 130 is displayed responsive to the user selecting the waterfall location. Selecting the waterfall in the second user interface 125 causes the calling engine to transmit a request to the second player to accept the location change. The third user interface 130 represents a waiting room 131 where the first player waits in the interim before the second player accepts the request to change the location. A cancel button 132 is provided that if selected, causes the location change to be canceled (e.g., the avatar of the first player returns to the camping location).

Once both players provide permission to change the location, the virtual experience application generates a fourth user interface 150 to indicate that the calling engine is changing the location for both players. The fourth user interface 150 includes a first player icon 151 and a second player icon 152 to illustrate the two players that are moving to the waterfall location.

Responsive to moving corresponding avatars for the first player and the second player to the waterfall location, the calling engine displays the fifth user interface 175 for the first player. The background 176 for the virtual experience is now the waterfall. The second player 180 is also in the waterfall location.

Several technical difficulties arise from transferring players to new locations during a video call within a virtual experience. First, the video call is coordinated between three groups of devices: a server that creates instances; microservices, such as a calling service and a notification service; and client devices that connect to the same instance for the video call. The groups coordinate calls to ensure that the client devices are connected to a video call. If the video call is not properly coordinated, the server may create instances for a video call even when the users are no longer connected, which unnecessarily demands server resources and may limit the server's bandwidth and capacity to provide services to other users.

Second, changing locations may present a security risk to players. A first location is associated with a first instance that is hosted by the server. Switching from the first location to a second location may expose information about players. In addition, a developer may initiate the video call between the server and the users and invite other users that do not have permission to be part of a call. This type of call initiation (e.g., with potential violation of privacy) can cause users to lose trust in the security provided by the calling engine. In addition, users that join calls without permission may be able to harass other users.

In some embodiments, the technology described herein advantageously solves the problem of managing different requests for calls and changing locations within the virtual experience. A calling engine stored on an online virtual experience server coordinates with microservices and client devices to create instances in the virtual experience, to enable calls within the instances that end when one or more users leave the video calls, and that maintain privacy for the users.

### Network Environment

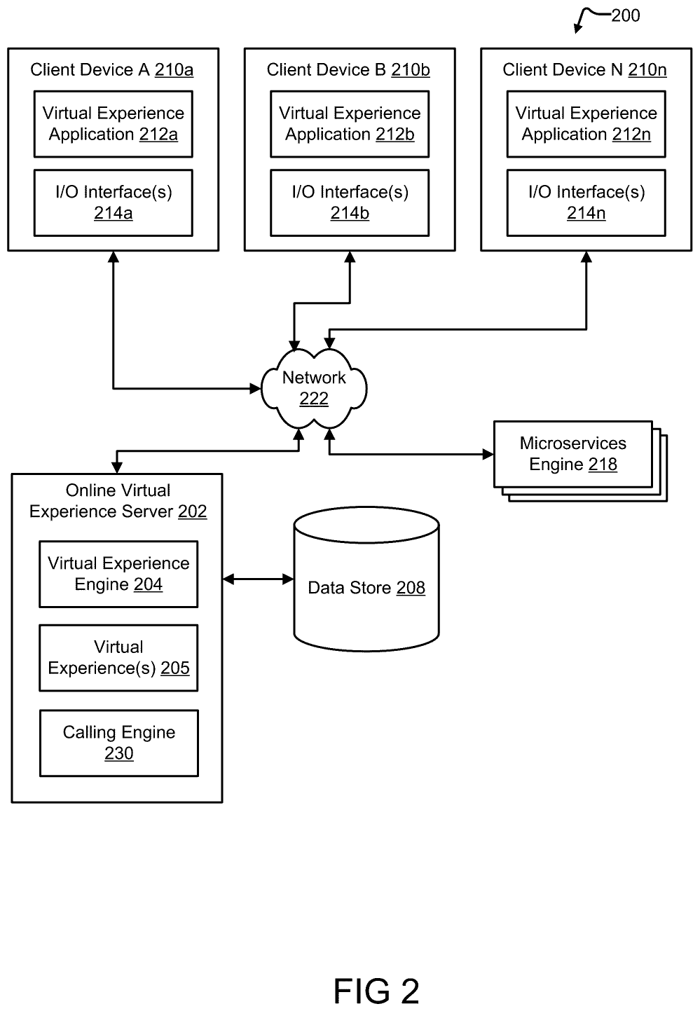

FIG. 2 illustrates an example network environment 200, in accordance with some embodiments of the disclosure. FIG. 2 and the other figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral (e.g., “210” in the text refers to reference numerals “210a,” “210b,” and/or “210n” in the figures).

The network environment 200 (also referred to as a “platform” herein) includes an online virtual experience server 202, a data store 208, a client device 210 (or multiple client devices), and a microservices engine 218, all coupled via a network 222.

The online virtual experience server 202 can include, among other things, a virtual experience engine 204, one or more virtual experiences 105, and a calling engine 230. The online virtual experience server 202 may be configured to provide virtual experiences 205 to one or more client devices 110, and to provide calling functionality via the calling engine 230, in some embodiments.

Data store 208 is shown coupled to online virtual experience server 202 but in some embodiments, can also be provided as part of the online virtual experience server 202. The data store may, in some embodiments, be configured to store advertising data, user data, engagement data, and/or other contextual data in association with the calling engine 230.

The client devices 210 (e.g., 210a, 210b, 210n) can include a virtual experience application 212 (e.g., 212a, 212b, 212n) and an I/O interface 214 (e.g., 214a, 214b, 214n), to interact with the online virtual experience server 202, and to view, for example, graphical user interfaces (GUI) through a computer monitor or display (not illustrated). In some embodiments, the client devices 210 may be configured to execute and display virtual experiences, which may include virtual user engagement portal s as described herein.

Network environment 200 is provided for illustration. In some embodiments, the network environment 100 may include the same, fewer, more, or different elements configured in the same or different manner as that shown in FIG. 2.

In some embodiments, network 222 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some embodiments, the data store 208 may be a non-transitory computer readable memory (e.g., random access memory), a cache, a drive (e.g., a hard drive), a flash drive, a database system, or another type of component or device capable of storing data. The data store 208 may also include multiple storage components (e.g., multiple drives or multiple databases) that may also span multiple computing devices (e.g., multiple server computers).

In some embodiments, the online virtual experience server 202 can include a server having one or more computing devices (e.g., a cloud computing system, a rackmount server, a server computer, cluster of physical servers, virtual server, etc.). In some embodiments, a server may be included in the online virtual experience server 202, be an independent system, or be part of another system or platform. In some embodiments, the online virtual experience server 202 may be a single server, or any combination a plurality of servers, load balancers, network devices, and other components. The online virtual experience server 202 may also be implemented on physical servers, but may utilize virtualization technology, in some embodiments. Other variations of the online virtual experience server 202 are also applicable.

In some embodiments, the online virtual experience server 202 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 202 and to provide a user (e.g., user 214 via client device 210) with access to online virtual experience server 202.

The online virtual experience server 202 may also include a website (e.g., one or more web pages) or application back-end software that may be used to provide a user with access to content provided by online virtual experience server 202. For example, users (or developers) may access online virtual experience server 202 using the virtual experience application 212 on client device 210, respectively.

In some embodiments, online virtual experience server 202 may include digital asset and digital virtual experience generation provisions. For example, the platform may provide administrator interfaces allowing the design, modification, unique tailoring for individuals, and other modification functions. In some embodiments, virtual experiences may include two-dimensional (2D) games, three-dimensional (3D) games, virtual reality (VR) games, or augmented reality (AR) games, for example. In some embodiments, virtual experience creators and/or developers may search for virtual experiences, combine portions of virtual experiences, tailor virtual experiences for particular activities (e.g., group virtual experiences), and other features provided through the virtual experience server 202.

In some embodiments, online virtual experience server 202 or client device 210 may include the virtual experience engine 204 or virtual experience application 212. In some embodiments, virtual experience engine 204 may be used for the development or execution of virtual experiences 205. For example, virtual experience engine 204 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 204 may generate commands that help compute and render the virtual experience (e.g., rendering commands, collision commands, physics commands, etc.).

The online virtual experience server 202 using virtual experience engine 204 may perform some or all the virtual experience engine functions (e.g., generate physics commands, rendering commands, etc.), or offload some or all the virtual experience engine functions to virtual experience engine 204 of client device 210 (not illustrated). In some embodiments, each virtual experience 205 may have a different ratio between the virtual experience engine functions that are performed on the online virtual experience server 202 and the virtual experience engine functions that are performed on the client device 210.

In some embodiments, virtual experience instructions may refer to instructions that allow a client device 210 to render gameplay, graphics, and other features of a virtual experience. The instructions may include one or more of user input (e.g., physical object positioning), character position and velocity information, or commands (e.g., physics commands, rendering commands, collision commands, etc.).

In some embodiments, the client device(s) 210 may each include computing devices such as personal computers (PCs), mobile devices (e.g., laptops, mobile phones, smart phones, tablet computers, or netbook computers), network-connected televisions, gaming consoles, etc. In some embodiments, a client device 210 may also be referred to as a “user device.” In some embodiments, one or more client devices 210 may connect to the online virtual experience server 202 at any given moment. It may be noted that the number of client devices 210 is provided as illustration, rather than limitation. In some embodiments, any number of client devices 210 may be used.

In some embodiments, each client device 210 may include an instance of the virtual experience application 212. The virtual experience application 212 may be rendered for interaction at the client device 210. During user interaction within a virtual experience or another GUI of the online platform 200, a user may create an avatar that includes different body parts from different libraries. A user may select an option in a graphical user interface associated with the virtual experience 205 to call another user.

The virtual experience engine 204 may generate an instance that hosts a virtual location for a virtual experience 205. The virtual locations have different attributes. For example, one virtual location may be a forest with trees, rocks, etc.; another virtual location may be a beach with sand, water, tropical trees, etc. In some embodiments, a first online virtual experience server 202a may generate a first instance of a virtual experience 205 and a second online virtual experience server 202b may generate a second instance of the virtual experience 205 where each instance is associated with a different virtual location in the virtual experience 205.

The virtual experience application 212 on the client device 210 joins the virtual experience 205 by maintaining a connection to the online virtual experience server 202 for the particular virtual experience 205. The calling engine 230 handles certain aspects of a video call. In some embodiments, the calling engine 230 enables voice chat for the video call.

The microservices engines 218 may include container-based individually deployable services. The microservices engines 218 may allow for each service to function without disrupting other services and without disrupting the online virtual experiences server 202. For example, a call service microservices engine 218a advantageously maintains a state of a call even in instances where the virtual experience engine 204 ends one instance of the virtual experience 205 and creates another instance. In some embodiments, an individual microservice communicates with the other microservices and the online virtual experiences server 202 through the use of Hypertext Transfer Protocol (HTTP).

The microservices engines 218 handle services associated with a video call. For example, the microservices engines 218 may include a call service microservices engine 218a that maintains information about the video call, such as the call state; performs network requests; propagate state changes to the calling engine 230; and includes an event listener that identifies events that trigger a change to the call state. In some embodiments, the calling state includes a call status (e.g., idle, ringing, active), a call identifier, information about participants (e.g., a user identifier, a user name, a status (e.g., invited, joined), and an experience (e.g., place identifier and an instance identifier). In some embodiments, the client device 210 and the calling engine 230 maintain the video call using Voice over IP (VoIP).

The microservices engine 218 may also include a notification microservices engine 218b that enables push notifications, such as a message to notify a second user that a first user is calling. The microservices engine 218 may include a join microservices engine 218c that performs a join between a client device 210 and the video call. In some embodiments, the virtual experience engine 204, calling engine 230, and the microservices engine 218 each store or manage a state of the video call and synchronize changes in call state with the other groups.

In some embodiments, the microservices engine 218 stores a state of the video call but does not have access to granular details of the video call. For example, the microservices engine 218 may have access to information about a call being accepted, but the calling engine 230 may not provide the microservices engine 218 with information about whether the calling engine 230 successfully joined the online virtual experience server 202. As a result, the client device 210 may provide information about the success of the connection to the microservices engine 218 (e.g., the call service microservices engine 218a).

### Call Invite

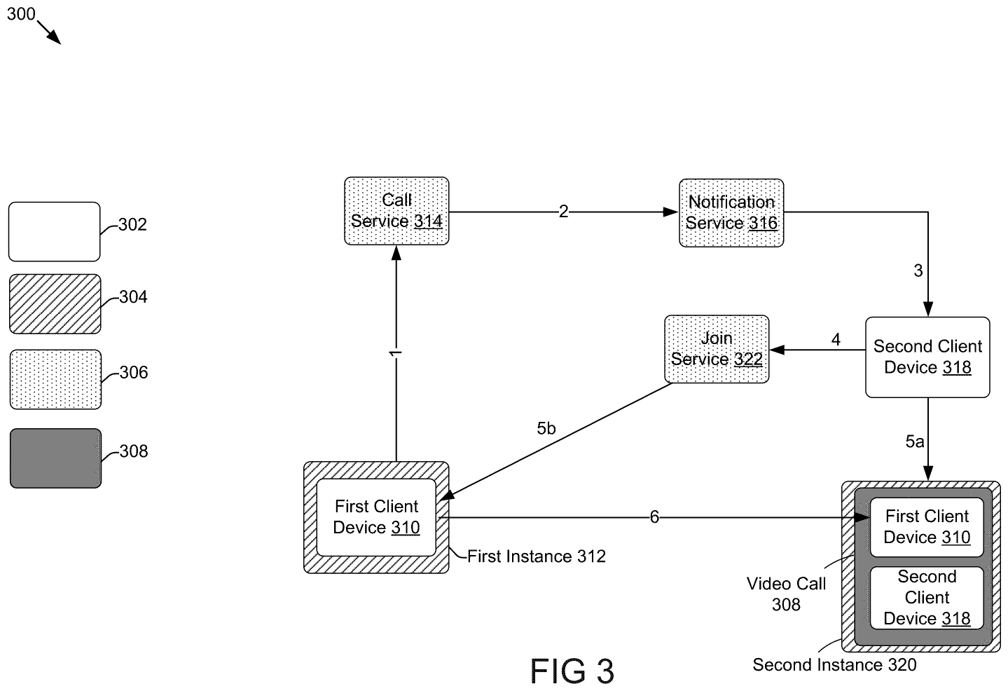

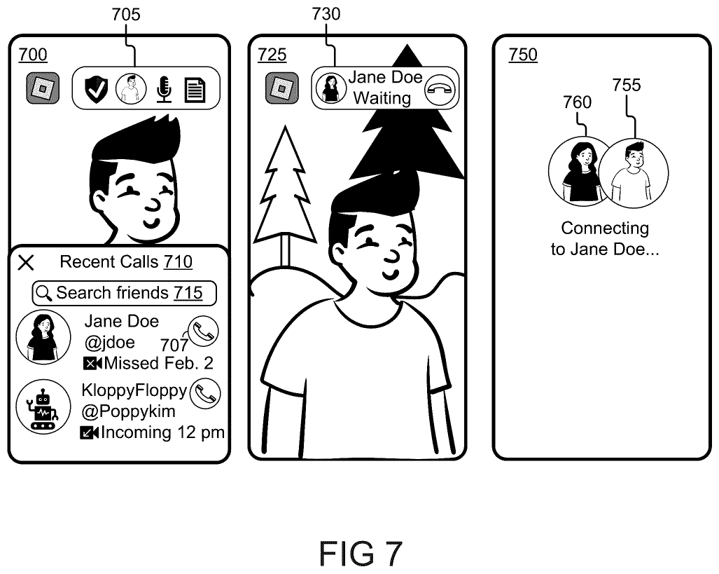

FIG. 3 is an example block diagram 300 that illustrates a call invitation process, according to some embodiments described herein. The call invite block diagram 300 includes four entities: client devices 302, a virtual experience server 304, microservices 306, and a video call 308. A virtual experience engine generates a first instance 312 of the virtual experience on the virtual experience server 304 that is joined by a first client device 310. A user associated with the first client device 310 may request a call between the first client device 310 and a second client device 318. FIG. 7, which is described in greater detail below, illustrates an example user interface for requesting the call.

A call engine initiates a video call 308 between the first client device 310 and the second client device 318 by transmitting a message to a call service 314, which is a type of microservice 306. The message includes an indication that the video call 308 will be hosted on a second instance 320 of the virtual experience server 304. In some embodiments, the message also requests the call service 314 to update a state of the call.

The call service 314 triggers a push notification by commanding a notification service 316, which is another type of microservice 306, to notify the second client device 318 that the first client device 310 is calling.

The notification service 316 transmits an incoming call notification to the second client device 318. The incoming call notification includes an option to accept or reject the video call 308. The second client device 318 transmits a receive call confirmation and request to update the state to the call service 314.

The second client device 318 accepts the call. The second client device 318 transmits an answer call confirmation and a network request to the call service 314. A join service 322, which is another type of microservice 306, performs a join of the second client device 318 to the virtual experience, e.g., the second client device 318 joins the second instance 320 of the virtual experience on the virtual experience server 304.

The second client device 318 teleports to a second instance 320 of the virtual experience. In some embodiments, teleportation occurs when the virtual experience engine associates the second client device 318 with the second instance 320 of the virtual experience, thereby causing an avatar associated with the second client device 318 to be located in the second instance 320 of the virtual experience. In addition, the join service 322 transmits a message to the first client device 310 that notifies the first client device 310 that the second client device 318 accepted the video call 308.

The first client device 310 teleports to the second instance 320 of the virtual experience such that an avatar associated with the first client device 310 is displayed as being part of the second instance 320. In some embodiments, the virtual experience engine performs teleportation by removing the first client device 310 from being associated with the first instance 312 and associates the first client device 310 with the second instance 320.

The first client device 310 and the second client device 318 individually transmit a message to the virtual experience server 304 to notify the virtual experience server 304 that the video call 308 is being hosted on the second instance 320 of the virtual experience. The virtual experience engine generates a participant list that includes the eligible participants. The eligible participants may include other client devices associated with users that receive a call request from the first client device 310 and/or the second client device 318 (e.g., as a group call), etc.

### Teleportation

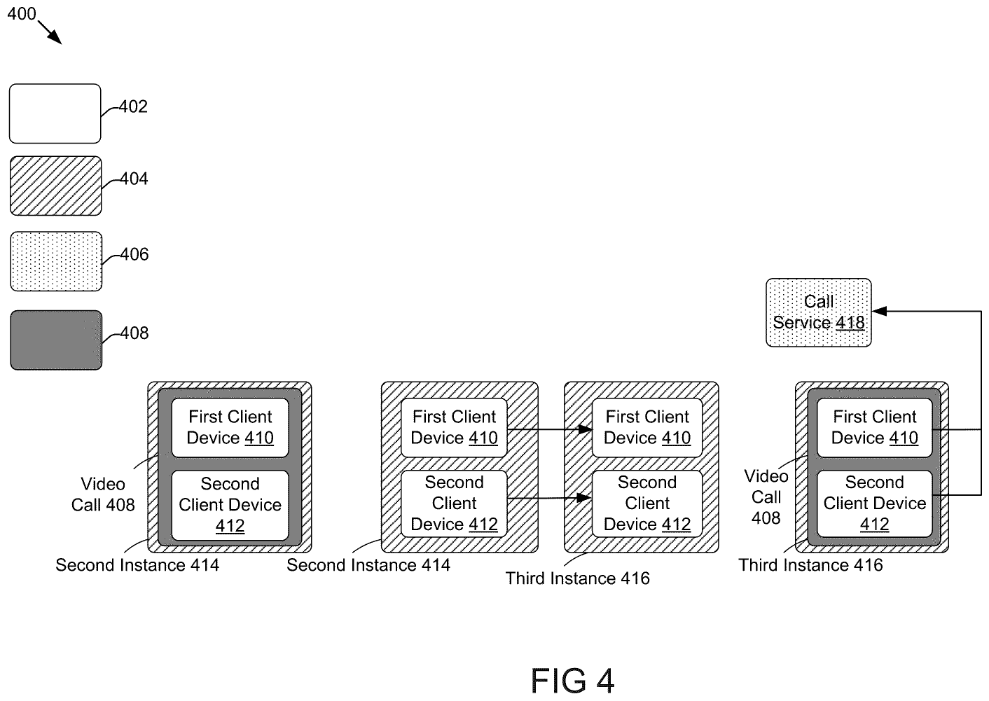

FIG. 4 is an example block diagram that illustrates an automatic detection of a call transfer, according to some embodiments described herein. The call invite block diagram 400 includes four entities: client devices 402, virtual experience servers 404, microservices 406, and a video call 408.

A second instance 414 of a virtual experience on a first virtual experience server 404 hosts a video call 408 where a first client device 410 and a second client device 412 are participating. The virtual experience is a second instance 414 based on the explanation with reference to FIG. 3.

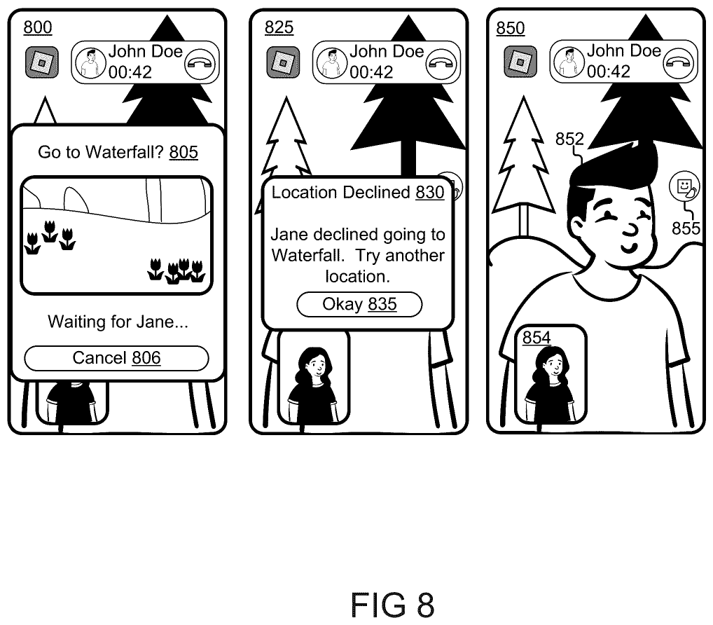

The first client device 410 provides a teleportation request to change from a first virtual location to a second virtual location. The second user interface 125 in FIGS. 1A is an example of a user interface for selecting different virtual locations. If the second client device 412 approves the request, the teleportation process starts. The fourth user interface 150 in FIG. 1B is an example user interface that is displayed responsive to the second client device 412 approving the request. If the second client device 412 denies the request, FIG. 8 illustrates examples of the resulting user interfaces.

In some embodiments, the teleportation request includes an identification of a virtual location to be teleported to (e.g., a place identifier for the virtual location), an identification of one or more client devices to invite to the virtual location (e.g., an array that contains a player instance representing the users associated with respective client devices to teleport, and custom properties), such as a reserved server access code and a server instance identifier.

The virtual experience engine determines whether the first client device 410 matches at least one call participant in a participant list. For example, the virtual experience engine may compare a unique identifier associated with the first client device 410 and a unique identifier that is on the participant list, compare internet protocol (IP) addresses, etc. If the first client device 410 does not match at least one call participant, the virtual experience engine may instruct a call service 418 to end the video call 408.

The virtual experience engine determines whether the virtual location identified in the teleportation request supports video calls 408. If the virtual location does not support video calls 408, the virtual experience engine teleports the first client device 410 and the second client device 412 while the call is ended. If the virtual location supports the video call 408, the video call 408 is associated with the third instance 416 of the virtual experience on a second virtual experiences server 404.

The virtual experience engine disassociates the second instance 414 with the video call 408. The first client device 410 teleports to the third instance 416 and the second client device 412 teleports to the third instance 416. Avatars associated with the first client device 410 and the second client device 412 are displayed in association with the third instance 416. In some embodiments, the virtual experience engine provides user data to the third instance 416 that should be persistent between the second instance 414 and the third instance 416. The user data may include a reserved server access code and a place identifier for the third instance 416.

After the first client device 410 and the second client device 412 arrive in the third instance 416 of the virtual experience on the second virtual experience server 404, each of the first client device 410 and the second client device 412 send a request to the call service 418 to update the call service 418 that the video call 408 is now associated with the third instance 416. In some embodiments, the request to the call service 418 is transmitted by all client devices that are associated with a video call 408 to ensure that the call service 418 receives the request. The first client device 410 and the second client device 412 also transmit a request to the call engine to associate the third instance 416 with the video call 408.

The call service 418 may use a place identifier, an instance identifier, and a call identifier. This information is used to track when client devices are associated with different instances of a virtual experience and as a fail safe to determine when a call has ended. The call service 418 uses a determination about whether a call has ended in situations where all client devices associated with an instance crash before the client devices report to the call service 418 that the call is over. The call service 418 may use the information to determine whether a client device is able to place a video call 408. For example, if a first client device 410 is part of a video call 408, the first client device 410 may be prohibited from joining another video call 408 based on the information tracked by the call service 418.

In some embodiments, the teleportation fails for one or more of the client devices. In response to a failure to teleport the one or more client devices, the calling engine notifies the call service 418 that the video call 408 has ended. In response to receiving the notification from the calling engine that the video call 408 has ended, the call service 418 instructs a notification service to transmit notifications to each of the client devices 410, 412 that the video call 408 has ended.

### Security Response

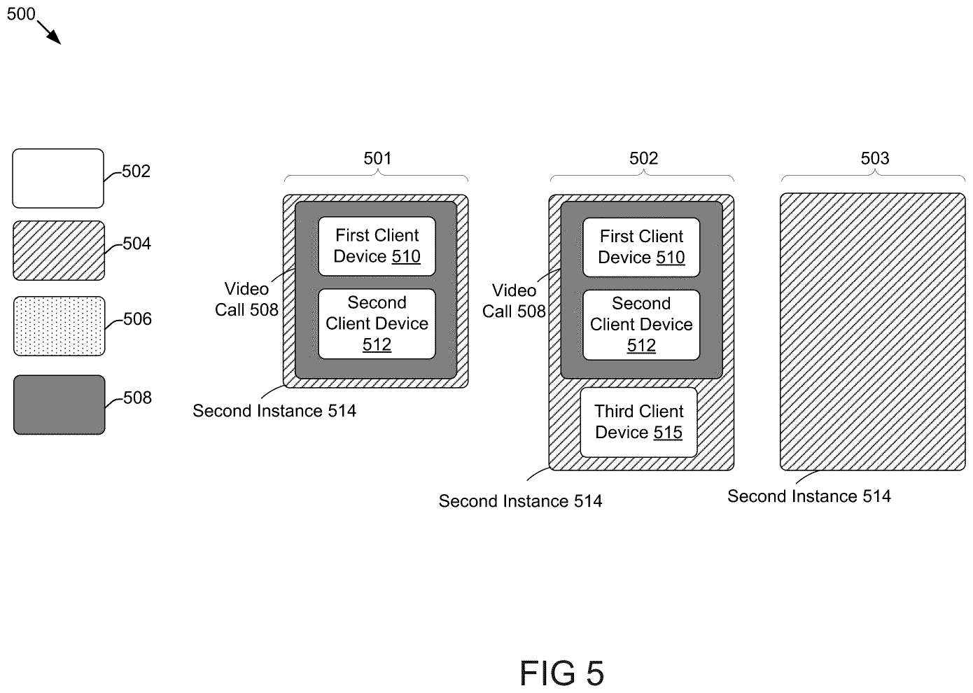

FIG. 5 is an example block diagram 500 that illustrates how call privacy is enforced, according to some embodiments described herein. The call invite block diagram 500 includes four entities: client devices 502, a virtual experience server 504, microservices 506, and a video call 508.

In a first example 501, a second instance 514 of a virtual experience on the virtual experience server 504 hosts a video call 508 where a first client device 510 and a second client device 512 are participating. The virtual experience is a second instance 514 based on the explanation with reference to FIG. 3.

In a second example 502, a third client device 515 joins the second instance 514 of the virtual experience. For example, the virtual experience engine may teleport the third client device 515 to the second instance 514.

In a third example 503, the calling engine determines that the third client device 515 is not associated with the video call 508. The calling engine ends the video call 508. In some embodiments, the first client device 510, the second client device 512, and the third client device 515 may remain associated with the second instance 514 of the virtual experience although the video call 508 has ended.

### Client Crash

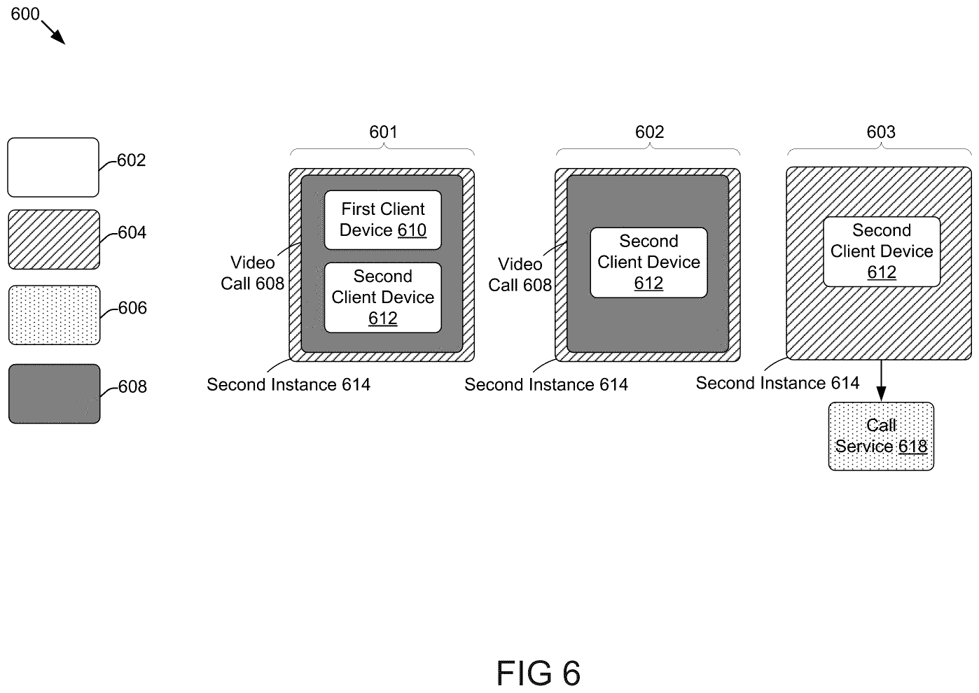

FIG. 6 is an example block diagram 600 that illustrates detection of a client crash, according to some embodiments described herein. The call invite block diagram 600 includes four entities: client devices 602, a virtual experience server 604, microservices 606, and a video call 608.

In a first example 601, a second instance 614 of a virtual experience on the virtual experience server 604 hosts a video call 608 where a first client device 610 and a second client device 612 are participating. The virtual experience is a second instance 614 based on the explanation with reference to FIG. 3.

In a second example 602, the first client device 610 crashes and disconnects from the second instance 614 of the virtual experience.

In a third example 603, after a grace period (e.g., when a time period exceeds a predetermined threshold delay), a calling engine determines that the first client device 610 is not returning to the video call 608. The calling engine sends a request to end the call to a call service 618 and disassociates the second instance 614 of the virtual experience from the video call 608.

After ending the call, the call service 618 instructs a notification service to transmit notifications to the second client device 612 (i.e., the remaining client device) that the video call 608 has ended.

### Example User Interfaces

FIG. 7 includes example user interfaces that illustrate how to place a video call and teleport, according to some embodiments described herein. In some embodiments, FIG. 7 illustrates example user interfaces that are displayed before the first user interface 100 in FIG. 1A.

FIG. 7 includes a first user interface 700 with a settings bar 705 and a list of recent calls 710. A first user may select a phone icon, such as the first phone icon 707, to call one of the first user's contacts. The first user may also enter a name or a handle into the search friends text field 715 to find another user to call. In this example, the first user selects the first phone icon 707 to call Jane Doe.

Responsive to the first user calling a second user, the second user receives a notification that the first user is calling. The second user may accept the video call, reject the video call, or the video call invitation expires. The second user interface 725 includes an update bar 730 to inform the first user that the second user, Jane Doe, has not yet responded to the video call invitation.

The second user accepts the video call invitation. The third user interface 750 includes icons of the first user 755 and the second user 760 while the second user device is teleported to the instance of the virtual experience.

FIG. 8 includes example user interfaces that illustrate a suggestion to transfer a call that is declined, according to some embodiments described herein. The first user interface 800 is similar to the third user interface 130 in FIG. 1A. The first user interface 800 includes a screen 805 where the first user selected to change the camping virtual location to a waterfall virtual location. While the first user waits for the second user to accept or reject the waterfall virtual location, the first user has the option of cancelling the invite by selecting the cancel button 806.

The second user interface 825 is displayed responsive to the second user declining to change virtual locations. The second user interface includes a screen 830 explaining that “Jane declined going to Waterfall. Try another location.”

Responsive to the first user selectin the okay button 835 in the second user interface 825, a third user interface 850 is displayed of the first user 852 and the second user 854 in the original camping virtual location. The first user may suggest another virtual location by selecting a teleport button 855.

### Example Method

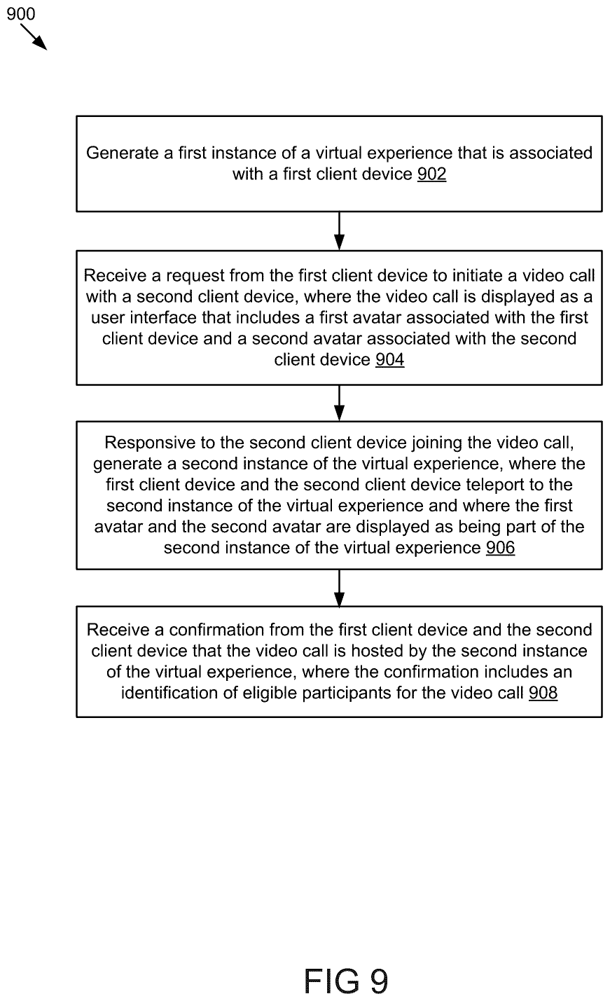

FIG. 9 is a flow diagram of an example method to enable a video call, according to some embodiments described herein. The method 900 may be performed by the online virtual experience server 202 in FIG. 2.

The method 900 may begin with block 902. At block 902, a first instance of a virtual experience that is associated with a first client device is generated. Block 902 may be followed by block 904.

At block 904, a request is received from the first client device to initiate a video call with a second client device, where the video call is displayed as a user interface that includes a first avatar associated with the first client device and a second avatar associated with the second client device. Block 904 may be followed by block 906.

At block 906, responsive to the second client device joining the video call, a second instance of the virtual experience is generated, where the first client device and the second client device teleport to the second instance of the virtual experience and where the first avatar and the second avatar are displayed as being part of the second instance of the virtual experience. Block 906 may be followed by block 908.

At block 908, a confirmation is received from the first client device and the second client device that the video call is hosted by the second instance of the virtual experience, where the confirmation includes an identification of eligible participants for the video call. Block 908 may be followed by block 910.

In some embodiments, the method 900 further includes receiving a request from the first client device to teleport the first client device to a third instance of the virtual experience, wherein the third instance is displayed with different background characteristics than the second instance; receiving a request from the second client device to teleport the second client device to the third instance of the virtual experience; and responsive to receiving requests from the first client device and the second client device to associate the third instance with the video call, associating the third instance with the video call. In some embodiments, the first instance and the second instance are associated with a first virtual location; the third instance is associated with a second virtual location; and the request to transfer the video call includes a selection of the second virtual location from a set of virtual locations. In some embodiments, prior to the second client device joining the video call, transmitting a request to a call service to trigger a push notification to the second client device to accept the video call and join the virtual experience.

In some embodiments, the method further includes generating, based on the confirmation, a participant list for the video call that includes a first identifier associated with the first client device and a second identifier associated with the second client device; receiving a request from a third client device to join the video call; and responsive to determining that the third client device is not on the participant list, rejecting the request from the third client device.

In some embodiments, the method further includes receiving a notification that a third client device is associated with the second instance of the virtual experience; determining that the third client device is not associated with the video call; and responsive to determining that the third client device is not associated with the video call, removing the first client device, the second client device, and the third client device from the second instance of the virtual experience.

In some embodiments, the method further includes determining that the first client device left the video call; and responsive to determining that the first client device is absent more than a predetermined amount of time, ending the video call.

### Example Computing Device

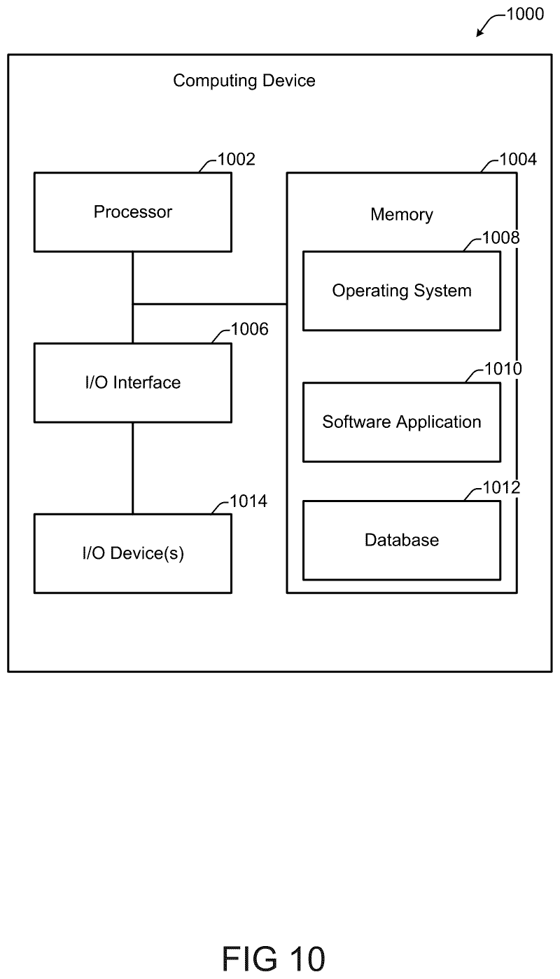

Hereinafter, a more detailed description of various computing devices that may be used to implement different devices and/or components illustrated in FIG. 2 is provided with reference to FIG. 10.

FIG. 10 is a block diagram of an example computing device 1000 which may be used to implement one or more features described herein, in accordance with some implementations. In one example, device 1000 may be used to implement a computer device, (e.g., 202, 210 of FIG. 2), and perform appropriate operations as described herein. Computing device 1000 can be any suitable computer system, server, or other electronic or hardware device. For example, the computing device 1000 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 1000 includes a processor 1002, a memory 1004, input/output (I/O) interface 1006, and audio/video input/output devices 1014 (e.g., display screen, touchscreen, display goggles or glasses, audio speakers, headphones, microphone, etc.).

Processor 1002 can be one or more processors and/or processing circuits to execute program code and control basic operations of the device 1000. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1004 is typically provided in device 1000 for access by the processor 1002, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1002 and/or integrated therewith. Memory 1004 can store software operating on the server device 1000 by the processor 1002, including an operating system 1008, software application 1010 and associated data 1012. In some implementations, the applications 1010 can include instructions that enable processor 1002 to perform the functions described herein. Software application 1010 may include some or all of the functionality required conduct voice calls and teleport users. In some implementations, one or more portions of software application 1010 may be implemented in dedicated hardware such as an application-specific integrated circuit (ASIC), a programmable logic device (PLD), a field-programmable gate array (FPGA), a machine learning processor, etc. In some implementations, one or more portions of software application 1010 may be implemented in general purpose processors, such as a central processing unit (CPU) or a graphics processing unit (GPU). In various implementations, suitable combinations of dedicated and/or general purpose processing hardware may be used to implement software application 1010.

For example, software application 1010 stored in memory 1004 can include instructions for generating a first instance of a virtual experience, receiving a request to initiate a video call, generating a second instance of the virtual experience, and receive a confirmation that a video call is hosted by the second instance. Any of software in memory 1004 can alternatively be stored on any other suitable storage location or computer-readable medium. In addition, memory 1004 (and/or other connected storage device(s)) can store instructions and data used in the features described herein. Memory 1004 and any other type of storage (magnetic disk, optical disk, magnetic tape, or other tangible media) can be considered “storage” or “storage devices.”

I/O interface 1006 can provide functions to enable interfacing the server device 1000 with other systems and devices. For example, network communication devices, storage devices (e.g., memory and/or data store 106), and input/output devices can communicate via interface 1006. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 10 shows one block for each of processor 1002, memory 1004, I/O interface 1006, software blocks 1008 and 1010, and database 1012. These blocks may represent one or more processors or processing circuitries, operating systems, memories, I/O interfaces, applications, and/or software modules. In other implementations, device 1000 may not have all of the components shown and/or may have other elements including other types of elements instead of, or in addition to, those shown herein. While the online server 102 is described as performing operations as described in some implementations herein, any suitable component or combination of components of online server 102, or similar system, or any suitable processor or processors associated with such a system, may perform the operations described.

A user device can also implement and/or be used with features described herein. Example user devices can be computer devices including some similar components as the device 1000, e.g., processor(s) 1002, memory 1004, and I/O interface 1006. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 1014, for example, can be connected to (or included in) the device 1000 to display images pre-and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., method 900) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

In situations in which certain implementations discussed herein may obtain or use user data (e.g., user demographics, user behavioral data, user contextual data, user settings for advertising, etc.) users are provided with options to control whether and how such information is collected, stored, or used. That is, the implementations discussed herein collect, store and/or use user information upon receiving explicit user authorization and in compliance with applicable regulations.

Users are provided with control over whether programs or features collect user information about that particular user or other users relevant to the program or feature. Each user for which information is to be collected is presented with options (e.g., via a user interface) to allow the user to exert control over the information collection relevant to that user, to provide permission or authorization as to whether the information is collected and as to which portions of the information are to be collected. In addition, certain data may be modified in one or more ways before storage or use, such that personally identifiable information is removed. As one example, a user's identity may be modified (e.g., by substitution using a pseudonym, numeric value, etc.) so that no personally identifiable information can be determined. In another example, a user's geographic location may be generalized to a larger region (e.g., city, zip code, state, country, etc.).

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various embodiments. In some embodiments, blocks and operations can be performed multiple times, in a different order, and/or at different times in the methods.

Various embodiments described herein include obtaining data from various sensors in a physical environment, analyzing such data, generating recommendations, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., client device 110 only; client+server device; etc.) and where the data analysis is performed (e.g., client device 110 only; client+server device; etc.). Data is utilized for the specific purposes as described herein. No data is shared with third parties without express user permission.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one embodiments of the description. The appearances of the segment “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method performed on one or more servers, the method comprising:
generating a first instance of a virtual experience that is associated with a first client device;
receiving a request from the first client device to initiate a video call with a second client device, wherein the video call is displayed as a user interface that includes a first avatar associated with the first client device and a second avatar associated with the second client device;
responsive to the second client device joining the video call, generating a second instance of the virtual experience, wherein the first client device and the second client device teleport to the second instance of the virtual experience and wherein the first avatar and the second avatar are displayed as being part of the second instance of the virtual experience; and
receiving a confirmation from the first client device and the second client device that the video call is hosted by the second instance of the virtual experience, wherein the confirmation includes an identification of eligible participants for the video call.

2. The method of claim 1, further comprising:
receiving a request from the first client device to teleport the first client device to a third instance of the virtual experience, wherein the third instance is displayed with different background characteristics than the second instance;
receiving a request from the second client device to teleport the second client device to the third instance of the virtual experience; and
responsive to receiving requests from the first client device and the second client device to associate the third instance with the video call, associating the third instance with the video call.

3. The method of claim 2, wherein:
the first instance and the second instance are associated with a first virtual location;
the third instance is associated with a second virtual location; and
the request to transfer the video call includes a selection of the second virtual location from a set of virtual locations.

4. The method of claim 2, further comprising:
prior to the second client device joining the video call, transmitting a request to a call service to trigger a push notification to the second client device to accept the video call and join the second instance of the virtual experience.

5. The method of claim 1, further comprising:
generating, based on the confirmation, a participant list for the video call that includes a first identifier associated with the first client device and a second identifier associated with the second client device;
receiving a request from a third client device to join the video call; and
responsive to determining that the third client device is not on the participant list, rejecting the request from the third client device.

6. The method of claim 1, further comprising:
receiving a notification that a third client device is associated with the second instance of the virtual experience;
determining that the third client device is not associated with the video call; and
responsive to determining that the third client device is not associated with the video call, removing the first client device, the second client device, and the third client device from the second instance of the virtual experience.

7. The method of claim 1, further comprising:
determining that the first client device left the video call; and
responsive to determining that the first client device is absent more than a predetermined amount of time, ending the video call.

8. A system comprising:
one or more processors; and
a memory coupled to the one or more processors, with instructions stored thereon that, when executed by the processor, cause the processor to perform operations comprising:
generating a first instance of a virtual experience that is associated with a first client device;
receiving a request from the first client device to initiate a video call with a second client device, wherein the video call is displayed as a user interface that includes a first avatar associated with the first client device and a second avatar associated with the second client device;
responsive to the second client device joining the video call, generating a second instance of the virtual experience, wherein the first client device and the second client device teleport to the second instance of the virtual experience and wherein the first avatar and the second avatar are displayed as being part of the second instance of the virtual experience; and
receiving a confirmation from the first client device and the second client device that the video call is hosted by the second instance of the virtual experience, wherein the confirmation includes an identification of eligible participants for the video call.

9. The system of claim 8, wherein the operations further include:
receiving a request from the first client device to teleport the first client device to a third instance of the virtual experience, wherein the third instance is displayed with different background characteristics than the second instance;
receiving a request from the second client device to teleport the second client device to the third instance of the virtual experience; and
responsive to receiving requests from the first client device and the second client device to associate the third instance with the video call, associating the third instance with the video call.

10. The system of claim 9, wherein:
the first instance and the second instance are associated with a first virtual location;
the third instance is associated with a second virtual location; and
the request to transfer the video call includes a selection of the second virtual location from a set of virtual locations.

11. The system of claim 9, wherein the operations further include:
prior to the second client device joining the video call, transmitting a request to a call service to trigger a push notification to the second client device to accept the video call and join the second instance of the virtual experience.

12. The system of claim 8, wherein the operations further include:
generating, based on the confirmation, a participant list for the video call that includes a first identifier associated with the first client device and a second identifier associated with the second client device;
receiving a request from a third client device to join the video call; and
responsive to determining that the third client device is not on the participant list, rejecting the request from the third client device.

13. The system of claim 8, wherein the operations further include:
receiving a notification that a third client device is associated with the second instance of the virtual experience;
determining that the third client device is not associated with the video call; and
responsive to determining that the third client device is not associated with the video call, removing the first client device, the second client device, and the third client device from the second instance of the virtual experience.

14. The system of claim 8, wherein the operations further include:
determining that the first client device left the video call; and
responsive to determining that the first client device is absent more than a predetermined amount of time, ending the video call.

15. A non-transitory computer-readable medium with instructions stored thereon that, when executed by one or more computers, cause the one or more computers to perform operations, the operations comprising:
generating a first instance of a virtual experience that is associated with a first client device;
receiving a request from the first client device to initiate a video call with a second client device, wherein the video call is displayed as a user interface that includes a first avatar associated with the first client device and a second avatar associated with the second client device;
responsive to the second client device joining the video call, generating a second instance of the virtual experience, wherein the first client device and the second client device teleport to the second instance of the virtual experience and wherein the first avatar and the second avatar are displayed as being part of the second instance of the virtual experience; and
receiving a confirmation from the first client device and the second client device that the video call is hosted by the second instance of the virtual experience, wherein the confirmation includes an identification of eligible participants for the video call.

16. The non-transitory computer-readable medium of claim 15, wherein the operations further include:
receiving a request from the first client device to teleport the first client device to a third instance of the virtual experience, wherein the third instance is displayed with different background characteristics than the second instance;
receiving a request from the second client device to teleport the second client device to the third instance of the virtual experience; and
responsive to receiving requests from the first client device and the second client device to associate the third instance with the video call, associating the third instance with the video call.

17. The non-transitory computer-readable medium of claim 16, wherein:
the first instance and the second instance are associated with a first virtual location;
the third instance is associated with a second virtual location; and
the request to transfer the video call includes a selection of the second virtual location from a set of virtual locations.

18. The non-transitory computer-readable medium of claim 16, wherein the operations further include:
prior to the second client device joining the video call, transmitting a request to a call service to trigger a push notification to the second client device to accept the video call and join the second instance of the virtual experience.

19. The non-transitory computer-readable medium of claim 15, wherein the operations further include:
generating, based on the confirmation, a participant list for the video call that includes a first identifier associated with the first client device and a second identifier associated with the second client device;
receiving a request from a third client device to join the video call; and
responsive to determining that the third client device is not on the participant list, rejecting the request from the third client device.

20. The non-transitory computer-readable medium of claim 15, wherein the operations further include:
determining that the first client device left the video call; and
responsive to determining that the first client device is absent more than a predetermined amount of time, ending the video call.
